(19) United States
(12) Patent Application Publication
(10) Pub. No.: US 2014/0362553 A1
(43) Pub. Date: Dec. 11, 2014

(54) THREE-DIMENSIONAL FORM FACTOR SUPPORTING HIGH-SPEED SIGNAL PROCESSING SYSTEMS

(71) Applicant: Lawrence James Scally, Colorado Springs, CO (US)

(72) Inventor: Lawrence James Scally, Colorado Springs, CO (US)

(21) Appl. No.: 13/912,152

(22) Filed: Jun. 6, 2013

(51) Int. Cl. H01R 12/73; H01R 43/00

(52) U.S. Cl. CPC H01R 12/73; H01R 43/00
USPC 361/792; 29/825

(57) ABSTRACT

A reconfigurable advanced rapid-prototyping environment (RARE) solution provides a three-dimensional (x, y, z) interconnection fabric that is a modular, reconfigurable, fully scalable high performance computing architecture. RARE allows processing nodes (modules) to communicate with other processing nodes (modules) in a three-dimensional mesh architecture where every processing node (module) has access to all other nodes (modules) in the system. The RARE architecture is a modular form-factor design which is fully stand-alone. It does not require the use of a backplane or chassis infrastructure for connectivity. RARE is widely scalable and provides full cross-channel communication in all three dimensions (x, y, z). RARE yields a scalable and morphable hardware architecture for a processing system where the system can scale by one module at a time without limit and it can take on any shape and those shapes can be easily changed.

### GOVERNMENT LICENSE RIGHTS

This invention was made with government support under the small business research program (SBIR) phase I (HQ0006-06-C-7415) and Phase II (HQ0006-08-C-7908) awarded by the Missile Defense Agency under technical guidance of the Naval Research Laboratory. The government has certain rights in the invention.

### BACKGROUND OF THE INVENTION

The present invention relates to electronics architectures and, more particularly, to a three dimensional form factor supporting high-speed processing systems.

Processing performance has increased significantly over the last few decades. Traditional systems require the use of large backplanes which add weight, size and cost to the overall system and constrain incremental scalability. They also are a two-dimensional architecture that severely limits the interconnectivity between processing nodes. When all data communications are limited to a backplane or other two dimensional processing architecture, systems cannot take advantage of the improved processing performance. Data movement and scalability become the constraining parameters in the system.

As can be seen, there is a need for a scalable architecture fabric interconnection scheme for high performance data transport between processing nodes.

### SUMMARY OF THE INVENTION

In one aspect of the present invention, a signal processing system architecture comprises a plurality of boards having electrical components disposed thereupon; and electrical connectors on each of the plurality of boards, the electrical connectors allowing the plurality of boards to be connected in an x-direction, a y-direction and a z-direction.

In another aspect of the present invention, a method of providing full cross-channel communication between processing nodes of a signal processing system architecture comprises disposing electrical components on a plurality of processing nodes, the electrical components adapted for signal processing; and interconnecting each of the plurality of processing nodes, in any of an x-direction, a y-direction and a z-direction, wherein each one of the plurality of nodes can communicate with each other ones of the plurality of the processing nodes.

These and other features, aspects and advantages of the present invention will become better understood with reference to the following drawings, description and claims.

### BRIEF DESCRIPTION OF THE DRAWINGS

FIG. 1 is an exploded view of an exemplary concept rendering showing Z-axis connectivity of a reconfigurable advanced rapid-prototyping environment (RARE) solution according to the present invention;

FIG. 2 is an exploded view of an exemplary concept rendering showing X-axis, Y-axis, and Z-axis connectivity of a RARE solution according to the present invention; and

FIG. 3 is a connected view of the RARE solution of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a reconfigurable advanced rapid-prototyping environment (RARE) solution that provides a three-dimensional (x, y, z) interconnection fabric that is a modular, reconfigurable, fully scalable high performance computing architecture. RARE allows processing nodes to communicate with other processing nodes in a three-dimensional mesh architecture where every processing node has access to all other nodes in the system.

The RARE architecture is a completely new modular form-factor design which is fully stand-alone. It does not require the use of a backplane or chassis infrastructure for connectivity. RARE is widely scalable and provides full cross-channel communication in all three dimensions (x, y, z). RARE yields a scalable and morphable hardware architecture for a processing system where the system can scale by one module at a time without limit and it can take on any shape and those shapes can be easily changed.

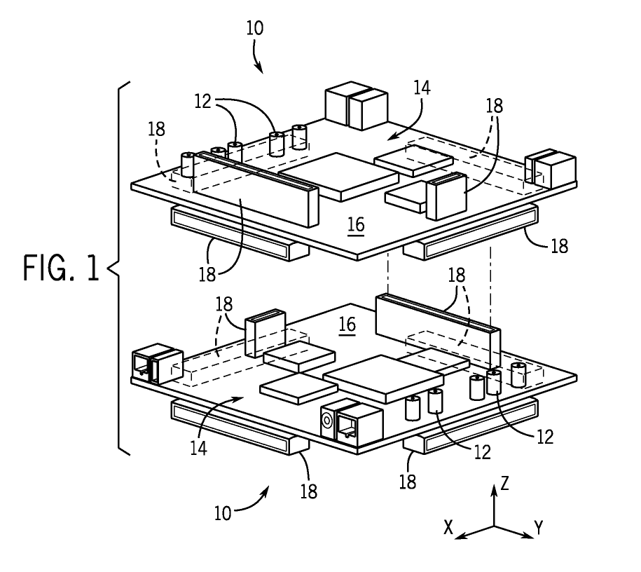

Referring now to FIGS. 1 through 3, a high speed signal processing system 20 includes a plurality of nodes (or modules) 10. Each node (module) includes a board or substrate 16 having electrical components 14 disposed thereupon. Electrical connectors 12, 18 are disposed on the plurality of boards or substrates 16 to allow interconnection of the nodes (modules) 10 in both an x-direction, a y-direction and a z-direction.

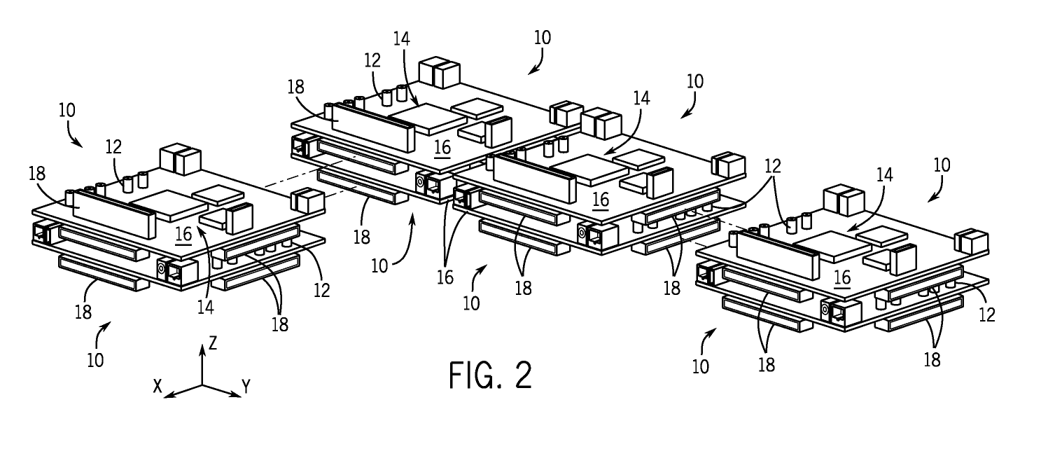

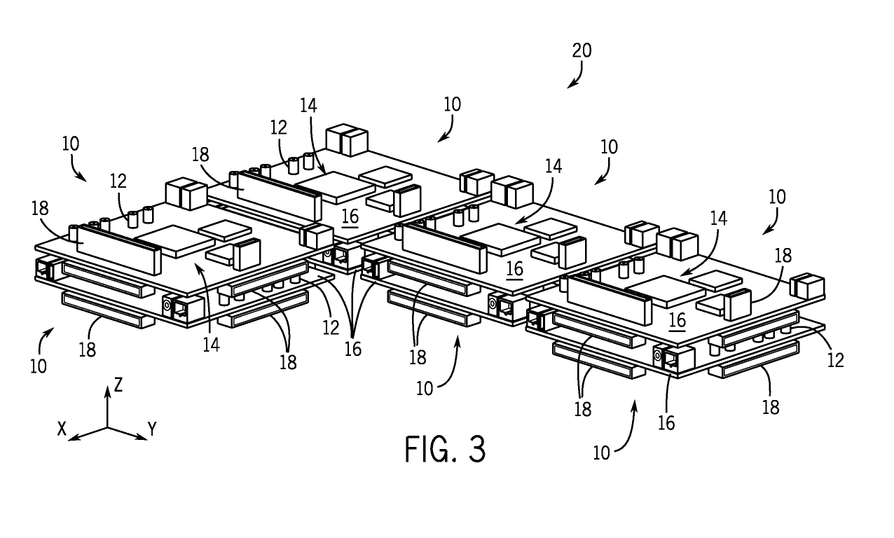

FIG. 1 shows a z-direction interconnection of two nodes (modules) 10, while FIG. 2 shows both an x-direction and a y-direction interconnection of nodes (modules) 10 (in this case, two nodes (modules) 10 already interconnected in the y and z-directions are connected to two additional nodes (modules) 10 in the x-direction and two additional nodes (modules) 10 in the y-direction). FIG. 3 shows an assembly or full system architecture 20, with the nodes (modules) 10 of FIG. 2 fully interconnected. The assembly or full system architecture 20 can provide a scalable architecture fabric interconnection scheme for high performance data transport between all processing nodes (modules). In the assembly, each processing node (module) 10 can have communications access to all other nodes in the system.

While a specific shape of a system architecture is shown in FIG. 3, the architecture for a processing system can be scaled, one module at a time, without limit, taking on any shape that can be easily changed as needed for a particular application.

It should be understood, of course, that the foregoing relates to exemplary embodiments of the invention and that modifications may be made without departing from the spirit and scope of the invention as set forth in the following claims.

What is claimed is:

1. A signal processing system architecture comprising:
a plurality of boards or substrates having electrical components disposed thereupon; and
electrical connectors on each of the plurality of boards or substrates, the electrical connectors allowing the plurality of boards or substrates to be connected in an x-direction, a y-direction and a z-direction.

2. The signal processing system architecture of claim 1, wherein the electrical connectors on each of the plurality of boards or substrates are the same on each of the plurality of boards or substrates, thereby permitting two adjacent ones of the plurality of boards or substrates to be joined in any of the x-direction, the y-direction and the z-direction.

3. The signal processing system architecture of claim 1, wherein the plurality of boards or substrates each form a processing node (module) of a data transport system.

4. The signal processing system architecture of claim 1, wherein a backplane or chassis is not required for connectivity of the plurality of boards or substrates.

5. The signal processing system architecture of claim 1, wherein full cross-channel communication is provided in three dimensions.

6. A method of providing full cross-channel communication between processing nodes of a signal processing system architecture, the method comprising:
disposing electrical components on a plurality of processing nodes (modules), the electrical components adapted for signal processing; and
interconnecting each of the plurality of processing nodes (modules), in any of an x-direction, a y-direction and a z-direction, wherein each one of the plurality of nodes (modules) can communicate with each other ones of the plurality of the processing nodes (modules).

7. The method of claim 6, wherein electrical connectors on each of the plurality of processing nodes (modules) are the same on each of the plurality of processing nodes (modules), thereby permitting two adjacent ones of the plurality of processing nodes (modules) to be joined in any of the x-direction, the y-direction and the z-direction.

8. The method of claim 6, wherein a backplane or chassis is not required for connectivity of the plurality of processing nodes (modules).
